(19) United States
(12) Patent Application Publication
(10) Pub. No.: US 2005/0122671 A1
(43) Pub. Date: Jun. 9, 2005

(54) Electronic device with improved hinge

(76) Inventor: Steven S. Homer, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/731,044

(22) Filed: Dec. 9, 2003

(51) Int. Cl. G06F 1/16

(52) U.S. Cl. 361/681

(57) ABSTRACT

In accordance with an embodiment of the present invention, an electronic device comprises a lid operable to pivot about at least one hinge from a protected orientation to a fully extended orientation.

### TECHNICAL FIELD OF THE INVENTION

The present invention relates generally to the field of electronic devices, and more particularly to an electronic device with an improved hinge.

### BACKGROUND OF THE INVENTION

Portable electronic devices, such as notebook computers, tablet PCs, etc., comprise of two main components—a base and a lid pivotally coupled to each other. The base typically includes a keyboard and the lid typically includes a display. When the portable electronic device is closed, the angle between the base and the lid is zero degrees with the surface of the display being substantially parallel to and facing the surface of the keyboard. When the electronic device is in an open configuration, the angle between the base and the lid depends on the desired viewing angle of the user and is often between ninety and one-hundred and eighty degrees.

In particular, a tablet PC may be put in a writing tablet configuration in which the display becomes the writing or user-input surface and the base with the keyboard is disposed below the lid. The mechanism used in such tablet PCs is prone to failure because the motion of the lid required to convert the tablet PC from the open or closed configuration to the writing tablet configuration is complex.

### SUMMARY OF THE INVENTION

In accordance with an embodiment of the present invention, an electronic device comprises a lid operable to pivot about at least one hinge from a protected orientation to a fully extended orientation.

In accordance with another embodiment of the present invention, an electronic device comprises a base, a lid and at least one hinge comprising a linking structure operable to couple the lid to the base and a pair of cooperatively engaged gears, a first gear of the pair of gears disposed in the base and a second gear of the pair of gears disposed in the lid to facilitate movement of the lid and the base relative to the linking structure.

In accordance with another embodiment of the present invention, an electronic device comprises a base and at least one hinge operable to couple a lid to the base, the lid operable to pivot about the at least one hinge from a protected orientation to a fully extended orientation.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a perspective view of an exemplary electronic device in accordance with an embodiment of the present invention;

FIG. 2A is a side elevational view illustrating the electronic device of FIG. 1 in a protected orientation in accordance with an exemplary embodiment of the present invention;

FIG. 2B is a side elevational view illustrating the electronic device of FIG. 2A in a fully extended orientation in accordance with an exemplary embodiment of the present invention;

FIG. 2C is a side elevational view illustrating the electronic device of FIG. 2A in an open configuration in accordance with an exemplary embodiment of the present invention;

FIG. 3A is a perspective view showing an interface between a hinge, a base and a lid of the electronic device of FIG. 1;

FIG. 3B is a side view taken along section 3B-3B of the electronic device of FIG. 3A;

FIG. 4 is another perspective view illustrating an interface between a hinge, a base and a lid of the electronic device of FIG. 1; and

FIG. 5 is a schematic diagram of a detent mechanism for use with a hinge in accordance with an alternative embodiment of the present invention.

### DETAILED DESCRIPTION OF THE DRAWINGS

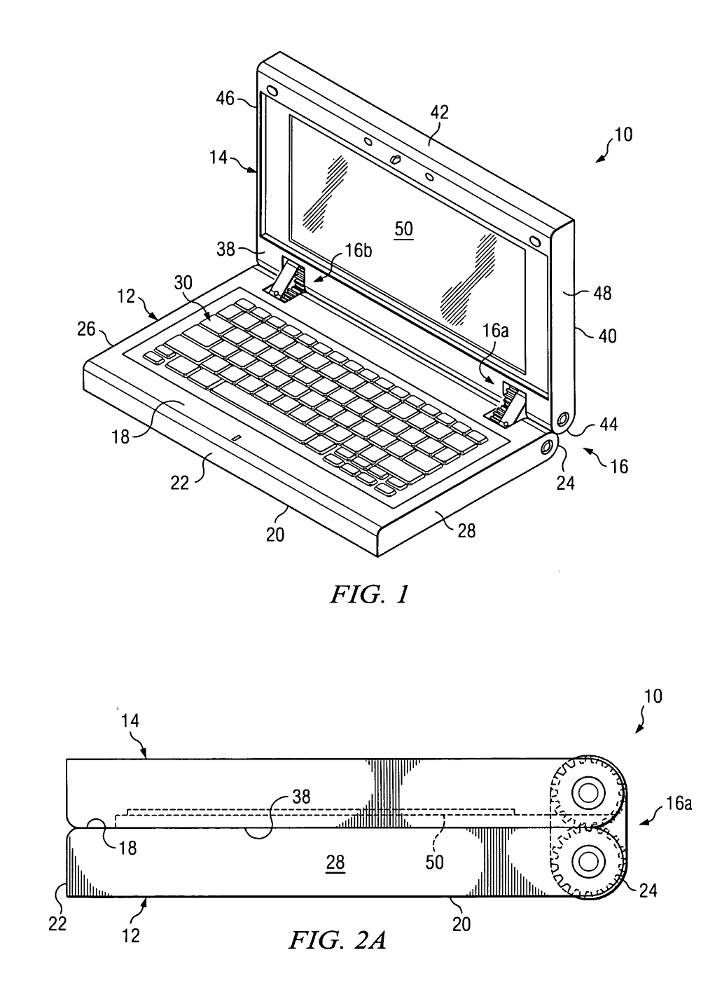

The preferred embodiment of the present invention and its advantages are best understood by referring to FIGS. 1 through 5 of the drawings, like numerals being used for like and corresponding parts of the various drawings.

FIG. 1 is a perspective view of an exemplary electronic device 10 in accordance with an embodiment of the present invention. Electronic device 10 may be a notebook computer, a cell phone, a digital dictionary, a tablet PC, a personal digital assistant, a calculator, or a device later to be developed, etc. Device 10 comprises a base 12 and a lid 14 coupled to base 12 using at least one hinge 16. In the illustrated embodiment, lid 14 is coupled to base 12 using two hinges 16a and 16b. If desired, in an alternative embodiment, a greater or fewer number of hinges may be used.

Base 12 comprises a top surface 18 and a bottom surface 20 opposite top surface 18. Base 12 also comprises a front side 22, a rear side 24 opposite front side 22, a left side 26 and a right side 28 opposite left side 26. Base 12 comprises a plurality of electronic components, such as a central processing unit, data storage devices, battery, etc., disposed within base 12. A user-input device, for example a keyboard 30 and/or a touch pad, is provided on top surface 18 of base 12.

Lid 14 comprises an inner surface 38, an outer surface 40 opposite inner surface 38, a front side 42, a rear side 44 opposite front side 42, a left side 46 and a right side 48 opposite left side 46. The illustrated embodiment of lid 14 comprises a display device 50 disposed on inner surface 38.

Due to coupling of base 12 and lid 14 using hinges 16a and 16b, base 12 and/or lid 14 may be rotated such that the angle formed by planes subscribed by top surface 18 and inner surface 38 may be any angle between zero degrees and an angle greater than one-hundred and eighty degrees. Lid 14 could be releasably locked in various positions along the path of the lid. In a releasably locked position, when a user releases the lid, the lid stays substantially in the same position.

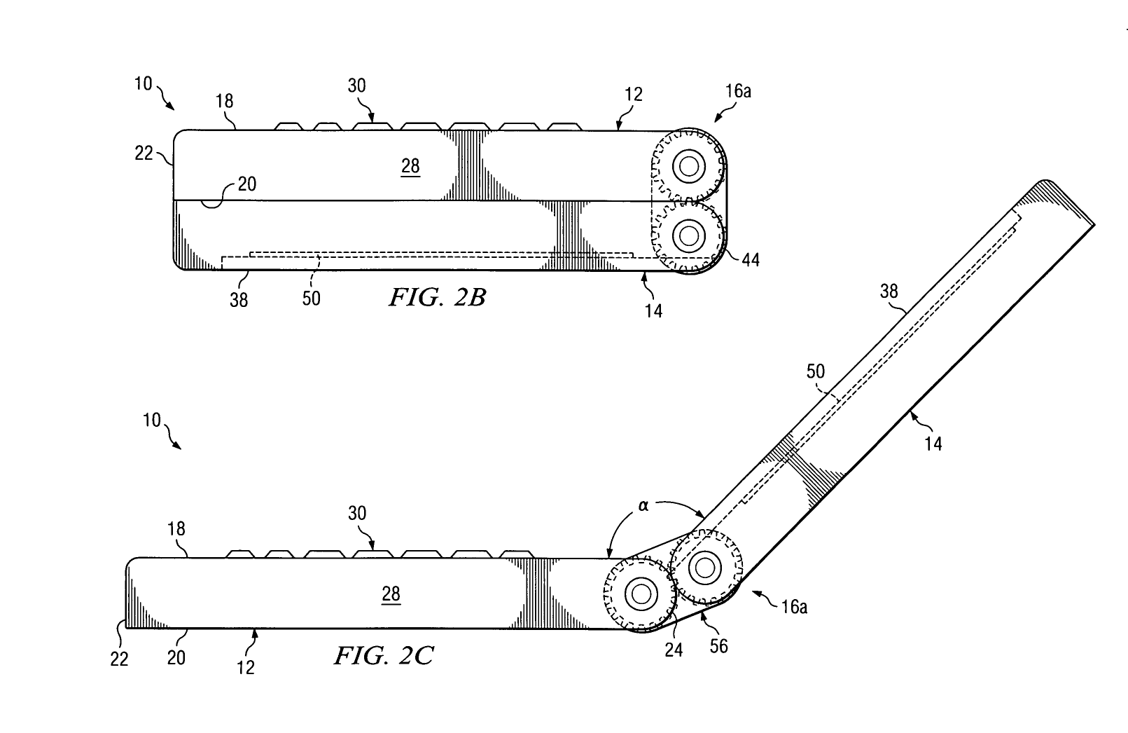

As illustrated in FIGS. 2A through 2C, electronic device 10 may be in any of a plurality of orientations. FIG. 2A is a side elevational view illustrating electronic device 10 in a protected orientation. For the sake of discussion and ease of understanding, the phrase “protected orientation” refers to the orientation when inner surface 38 and top surface 18 face each other and are adjacent to each other. FIG. 2A is an example of one implementation of the protected orientation.

FIG. 2B is a side elevational view illustrating electronic device 10 in a fully extended orientation. For the sake of discussion and ease of understanding, the phrase “fully extended orientation” refers to the orientation when outer surface 40 and bottom surface 20 face each other and are adjacent to each other. FIG. 2B is an example of one implementation of the fully extended orientation. Inner surface 38 is effectively able to pivot greater than one-hundred and eighty degrees about the longitudinal axes of hinges 16. In the example of FIG. 2B, base 12 and lid 14 are stacked back-to-back. It is to be understood that if the relative size of the lid and base are adjusted for design considerations, the base and lid may not be stacked back-to-back and instead one may be partially or wholly nested inside the other.

FIG. 2C is a side elevational view illustrating electronic device 10 in an open configuration. For the sake of discussion and ease of understanding, the phrase “open configuration” refers to any intermediate position of lid 14 between a protected orientation and a fully extended orientation. FIG. 2C is an example of one implementation of an open configuration. In the open configuration, an angle a between top surface 18 and inner surface 38 may be any angle greater than zero degrees, including any angle greater than one-hundred and eighty degrees.

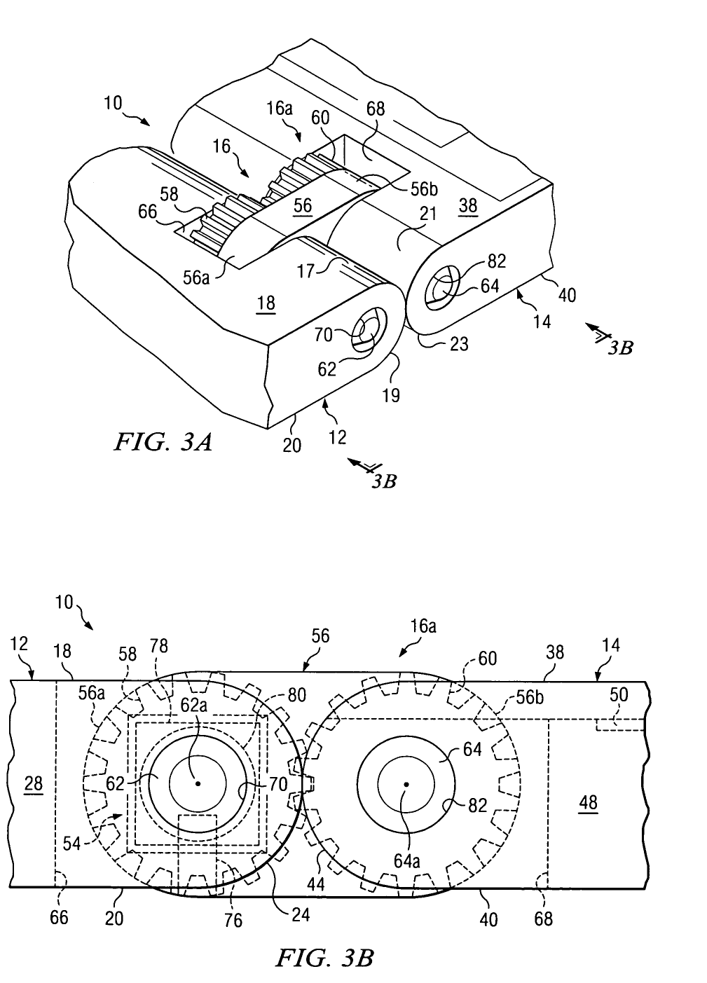

FIG. 3A is a perspective view showing an interface between hinge 16a, base 12 and lid 14 of electronic device 10 and FIG. 3B is a side view taken along section 3B-3B of electronic device 10 of FIG. 3A. A portion 17 of top surface 18 and a portion 19 of bottom surface 20 of base 12, in proximity to lid 14 is curved to facilitate pivotal movement of base 12. A portion 21 of inner surface 38 and a portion 23 of outer surface 40 of lid 14 in proximity to base 12 is curved to facilitate pivotal movement of lid 14. Hinge 16a comprises first and second gears 58 and 60 intermeshed with each other and disposed in recesses 66 and 68 of base 12 and lid 14, respectively. Preferably, the cross-sectional width of gear 58 is not greater than the thickness of base 12 and the cross-sectional width of gear 60 is not greater than the thickness of lid 14. In an exemplary embodiment, gear 58 is fixedly secured to base 12 and gear 60 is fixedly secured to lid 14. Gears 58 and 60 may be fixedly secured to base 12 and lid 14, respectively, using any method or manner now known or later developed. In an exemplary embodiment, gear 58 is an integral part of base 12 and gear 60 is an integral part of lid 14. Thus, gears 58 and 60 do not rotate with respect to base 12 and lid 14, respectively. However, gears 58 and 60 may rotate with respect to each other, facilitating pivotal movement of base 12 and/or lid 14 with respect to the other. In the illustrated embodiment, recess 66 is provided in the portion of base 12 in proximity to lid 14 and extends from top surface 18 to bottom surface 20. In the illustrated embodiment, recess 68 is provided in the portion of lid 14 in proximity to base 12 and extends from inner surface 38 to outer surface 40.

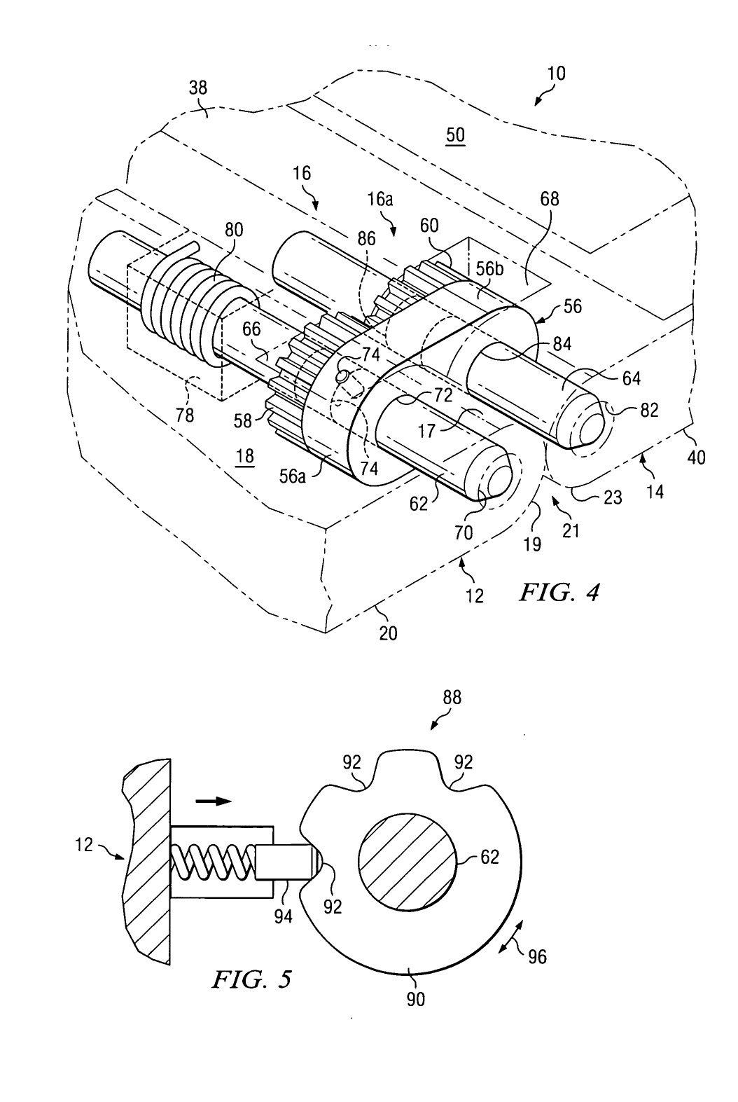

Hinge 16a also comprises a linking structure 56. Linking structure 56 has rounded or contoured opposite ends 56a and 56b that are disposed in recesses 66 and 68, respectively. Hinge 16a also comprises first and second elongated cylindrical mounting pins 62 and 64 with longitudinal axes 62a and 64a (FIG. 3B), respectively. Mounting pin 62 is disposed in a slot 70 formed in base 12 and extends through openings 72, 74 formed in end 56a of linking structure 56 and gear 58, respectively, as illustrated in FIG. 4. FIG. 4 is another perspective view illustrating an interface between hinge 16a, base 12 and lid 14 of electronic device 10. Mounting pin 62 and gear 58 are co-axial. Mounting pin 62 is locked to end 56a of linking structure 56 by a locking pin 76 extending through end 56a of linking structure 56 into mounting pin 62. Because mounting pin 62 is locked to linking structure 56, when linking structure 56 rotates, mounting pin 62 also rotates relative to gear 58 about axis 62a. Mounting pin 64 is disposed in a slot 82 (FIG. 4) formed in lid 14 and extends through openings 84, 86 formed in end 56b of linking structure 56 and gear 60, respectively. Mounting pin 64 and gear 60 are co-axial. Mounting pin 64 may be operable to rotate relative to linking structure 56 and gear 60 about axis 64a (FIG. 3B). The position of axis 64a of mounting pin 64 is not fixed with respect to base 12. Axis 64a is translatable and moves as lid 14 is pivoted with respect to base 12. In the illustrated embodiment, axes 62a and 64a are located within base 12 and lid 14 respectively and are parallel to each other.

Hinge 16a may also comprise a frictional clutch structure 54 as illustrated in FIG. 4. In the illustrated embodiment, clutch structure 54 comprises a housing 78 disposed within base 12. Clutch structure 54 operatively supports a coiled clutch spring member 80 in a fixed relationship relative to base 12. Clutch spring member 80 circumscribes and frictionally engages a portion of mounting pin 62 to thereby frictionally resist relative rotation between base 12 and mounting pin 62 about longitudinal axis 62a of mounting pin 62. With the exception of frictional clutch structure 54, hinge 16b is similar to hinge 16a. If desired, clutch structure 54 may be provided on both hinges 16a and 16b or only on hinge 16b.

Linking structure 56 couples base 12 and lid 14 via mounting pins 62 and 64 in a manner permitting them to rotate relative to linking structure 56 about the spaced-apart parallel axes 62a and 64a. Linking structure 56 also serves to maintain gears 58, 60 operatively intermeshed in a manner such that a forced rotation of either base 12 or lid 14 relative to linking structure 56 forcibly rotates the other (lid 14 or base 12, respectively) in an opposite direction relative to linking structure 56. For example, assuming that linking structure 56 were to be held stationary, a clockwise pivotal movement of lid 14 relative to linking structure 56 would cause a corresponding counterclockwise pivotal movement of base 12 relative to linking structure 56. Cabling associated with electronic device 10 between base 12 and lid 14 may pass through linking structure 56.

The coupling of base 12 and lid 14 for rotation about axes 62a and 64a, respectively, facilitates a smooth, controlled pivotal motion of lid 14 as it is moved between the protected orientation (FIG. 2A) and the fully extended orientation (FIG. 2B). When lid 14 is rotated between these two positions, the frictional resistance to rotation of linking structure 56 relative to base 12 provided by clutch spring number 80 permits lid 14 to automatically be held in any selected position (for example open configuration (FIG. 2C)), between the protected and fully extended orientations. It can be seen that frictional clutch structure 54 serves to keep lid 14 in a selected, open position relative to base 12 in response to pivoting of lid 14 to such open position.

While this frictional retention force is provided to hinge 16a by locking mounting pin 62 to linking structure 56, permitting mounting pin 62 to rotate in slot 70, and using clutch spring 80 to frictionally resist rotation of mounting pin 62 in its associated slot 70, other methods could alternately be utilized to provide hinge 16a with this frictional retention force.

For example, in an alternative embodiment, the mounting pin is locked in the slot, the locking pin is removed to permit relative rotation between the linking structure and the mounting pin, and a frictional force is created between the mounting pin and linking structure to frictionally resist relative rotation therebetween. In an alternative embodiment, the frictional retention force could be provided by structure located in the lid instead of in the base 12 and acting on the mounting pin.

FIG. 5 is a schematic diagram of a detent mechanism 88 for use with a hinge in accordance with an alternative embodiment of the present invention. Detent mechanism 88 may be used in place of or in addition to frictional clutch structure 54. In the illustrated embodiment, detent mechanism 88 includes a disc member 90 provided on mounting pin 62. A plurality of notches 92 are provided on an outer surface of disc member 90. Detent mechanism 88 also comprises a spring-loaded detent member 94 suitably supported in base 12. Detent member 94 is operable to releaseably engage with different ones of notches 92 as mounting pin 62 rotates in a direction as indicated by double-ended arrow 96 in FIG. 5. In an exemplary embodiment, the location of notches 92 corresponds to the desired pivotal “stops” for lid 14. Depending on the notch with which detent member 94 engages, electronic device 10 is in one of the plurality of orientations.

A technical advantage of an exemplary embodiment of the present invention is that the lid may be rotated greater than one-hundred and eighty degrees with respect to the base, thereby permitting placement of the electronic device in various orientations. Another technical advantage of an exemplary embodiment of the present invention is that frictional retention of the lid in one of a plurality of positions is facilitated. A further technical advantage of an exemplary embodiment of the present invention is that the gears are flush with the surface of the base and lid, respectively. Thus, the gears do not add to the bulk of the electronic device.

1. An electronic device, comprising a lid operable to pivot about at least one hinge from a protected orientation to a fully extended orientation.

2. The electronic device of claim 1, wherein the lid is operable to releasably lock in a position where an angle between an inner surface of the lid and a top surface of a base is greater than one-hundred and eighty degrees.

3. The electronic device of claim 1, wherein the at least one hinge facilitates reconfiguration of the electronic device from the protected orientation to the fully extended orientation by rotation of the lid about a longitudinal axis of the at least one hinge.

4. The electronic device of claim 1, wherein the at least one hinge facilitates reconfiguration of the electronic device from the protected orientation to the fully extended orientation by rotation of the lid by more than one-hundred and eighty degrees with respect to a base.

5. The electronic device of claim 1, wherein the lid comprises a display device.

6. An electronic device, comprising:
a base;
a lid; and
at least one hinge, comprising:
a linking structure operable to couple the lid to the base; and
a pair of cooperatively engaged gears, a first gear of the pair of gears disposed in the base and a second gear of the pair of gears disposed in the lid to facilitate movement of the lid and the base relative to the linking structure.

7. The electronic device of claim 6, further comprising a mounting pin disposed in the base and operable to couple an end of the linking structure to the base.

8. The electronic device of claim 6, further comprising a mounting pin disposed in the lid and operable to couple an end of the linking structure to the lid.

9. The electronic device of claim 6, further comprising a mounting pin operable to couple an end of the linking structure to the base, such that rotation of the linking structure causes the mounting pin to rotate about a longitudinal axis of the mounting pin.

10. The electronic device of claim 9, further comprising a clutch structure associated with the mounting pin and operable to resist movement of the base relative to the mounting pin.

11. The electronic device of claim 6, further comprising a mounting pin operable to couple an end of the linking structure to the lid and operable to rotate about a longitudinal axis of the mounting pin.

12. The electronic device of claim 6, wherein the first gear is fixedly secured to the base and the second gear is fixedly secured to the lid.

13. The electronic device of claim 6, further comprising a detent mechanism associated with a mounting pin disposed in the base, the detent mechanism operable to resist movement of the base relative to the mounting pin.

14. The electronic device of claim 6, further comprising a detent mechanism associated with a mounting pin disposed in the lid, the detent mechanism operable to resist movement of the lid relative to the mounting pin.

15. An electronic device, comprising:
a base; and
at least one hinge operable to couple a lid to the base, the lid operable to pivot about the at least one hinge from a protected orientation to a fully extended orientation.

16. The electronic device of claim 15, wherein the at least one hinge facilitates releasable locking of the lid in a position where an angle between an inner surface of the lid and a top surface of the base is greater than one-hundred and eighty degrees.
